(19) United States
(12) Patent Application Publication
(10) Pub. No.: US 2015/0102722 A1
(43) Pub. Date: Apr. 16, 2015

(54) WAVELENGTH CONVERSION BOARD AND ILLUMINATION DEVICE COMPRISING THE SAME

(71) Applicant: Panasonic Corporation, Osaka (JP)

(72) Inventors: TAKASHI OHBAYASHI, Osaka (JP); SEIGO SHIRAISHI, Osaka (JP); YOSHIHISA NAGASAKI, Osaka (JP); MITSURU NITTA, Osaka (JP)

(21) Appl. No.: 14/483,010

(22) Filed: Sep. 10, 2014

(30) Foreign Application Priority Data
Oct. 10, 2013 (JP) 2013-212744

(51) Int. Cl. F21K 99/00; G02B 27/14

(52) U.S. Cl. CPC F21K 9/56; G02B 27/141
USPC 313/498; 359/634; 428/447; 428/195.1; 428/213

(57) ABSTRACT

The present invention provides a wavelength conversion board comprising a substrate; one or more fluorescence members each containing a fluorescence substance for converting excitation light into fluorescence, the fluorescence member being disposed on or above the substrate; and a flexible gel disposed around the fluorescence member. The present invention also provides a wavelength conversion board comprising a substrate; a fluorescence member containing fluorescence substance for converting excitation light into fluorescence, the fluorescence member being disposed on or above the substrate; a fluent material disposed around the fluorescence member; a light-transmissive plate parallel to the substrate; and a sealing member disposed around the fluent material in a cross section of the wavelength conversion board. The fluorescence member is interposed between the light-transmissive plate and the substrate in the cross section of the wavelength conversion board.

### BACKGROUND

1. Technical Field

The present invention relates to a wavelength conversion board and an illumination device comprising the same.

2. Description of the Related Art

U.S. Pat. No. 8,371,706 discloses a light projection structure and a lighting system. As shown in FIG. 10, in order to provide a light projection structure with optical efficiency of a reflection member increased, especially, for a light-emitting member with a constant size, the light projection structure 910 disclosed in U.S. Pat. No. 8,371,706 is provided with a reflection member 911 having a reflecting face 911a formed into a deep concave face with a focal point f located near an apex t, and a light-emitting member 912 arranged at the apex t and its periphery for irradiating light by being excited by excitation light.

U.S. Pat. No. 8,550,677 discloses a light-emitting module and a vehicle lamp. As shown in FIG. 11, in order to provide a light-emitting module that realizes desired light distribution characteristics with high precision, the light-emitting module 32 disclosed in U.S. Pat. No. 8,550,677 includes a plurality of light-emitting units 36a, 36b, 36c, and 36d emitting light by using semiconductor light-emitting elements 42a, 42b, 42c, and 42d; and a substrate 34 supporting the plurality of light-emitting units arranged. Each of the light-emitting units includes light guide portions 41a, 41b, 41c, and 41d guiding light emitted by the semiconductor light-emitting elements so that the light emitted by the semiconductor light-emitting elements does not direct toward irradiation regions of adjacent light-emitting units. This makes the light emitted by the light-emitting units pass through a corresponding one of the light guide portions, to thereby reduce leakage of light into the irradiation regions of adjacent light-emitting units.

### SUMMARY

The present invention provides a wavelength conversion board comprising:

a substrate;

one or more fluorescence members each containing a fluorescence substance for converting excitation light into fluorescence, the fluorescence member being disposed on or above the substrate; and

a flexible gel disposed around the fluorescence member.

The present invention also provides a wavelength conversion board comprising:

a substrate;

one or more fluorescence members each containing fluorescence substance for converting excitation light into fluorescence, the fluorescence member being disposed on or above the substrate;

a fluent material disposed around the fluorescence member;

a light-transmissive plate parallel to the substrate; and

a sealing member disposed around the fluent material in a cross section of the wavelength conversion board, wherein

the fluorescence member is interposed between the light-transmissive plate and the substrate in the cross section of the wavelength conversion board.

The spirits of the present invention includes an illumination device comprising the above-mentioned wavelength conversion board.

The present invention provides a wavelength conversion board having high reliability. The present invention also provides an illumination device comprising such a wavelength conversion board.

### BRIEF DESCRIPTION OF THE DRAWINGS

FIG. 1A shows a cross-sectional view of a wavelength conversion board 10 according to the first embodiment;

FIG. 1B shows a cross-sectional view of a first variation of the wavelength conversion board 10 according to the first embodiment;

FIG. 1C shows a top view of the first variation of the wavelength conversion board 10 according to the first embodiment;

FIG. 2A shows a top view of the wavelength conversion board 10 according to the first embodiment;

FIG. 2B shows a top view of the wavelength conversion board 10 according to the first embodiment;

FIG. 2C shows a top view of the wavelength conversion board 10 according to the first embodiment;

FIG. 3A shows an enlarged cross-sectional view of the wavelength conversion board 10 according to the first embodiment;

FIG. 3B shows a cross-sectional view of the wavelength conversion board 10 having a flexible gel 2 which is thicker than a fluorescence member 1;

FIG. 4 shows a cross-sectional view of a second variation of the wavelength conversion board 10 according to the first embodiment;

FIG. 5A shows a schematic view of one step included in a method for fabricating the wavelength conversion board 10 according to the first embodiment;

FIG. 5B shows a schematic view of one step subsequent to FIG. 5A included in the method for fabricating the wavelength conversion board 10 according to the first embodiment;

FIG. 5C shows a schematic view of one step subsequent to FIG. 5B included in the method for fabricating the wavelength conversion board 10 according to the first embodiment;

FIG. 6 shows a cross-sectional view of the wavelength conversion board 10 according to the second embodiment;

FIG. 7A shows a top view of an illumination device according to the third embodiment;

FIG. 7B shows a cross-sectional view taken along the Xb-Xb line included in FIG. 7A;

FIG. 8 shows a cross-sectional view of an illumination device according to the fourth embodiment;

FIG. 9 shows a schematic view of a vehicle 100 according to the fifth embodiment;

FIG. 10 shows a schematic view of the light projection structure disclosed in U.S. Pat. No. 8,371,706; and

FIG. 11 shows a cross-sectional view of the light-emitting module disclosed in U.S. Pat. No. 8,550,677.

### DETAILED DESCRIPTION OF THE EMBODIMENTS

Hereinafter, the present invention is described in detail with reference to the drawings.

### First Embodiment

A wavelength conversion board according to the first embodiment will be described with reference to the drawings.

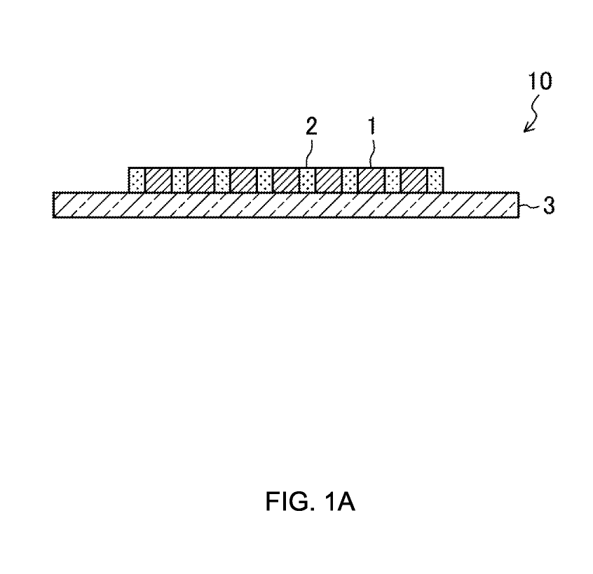

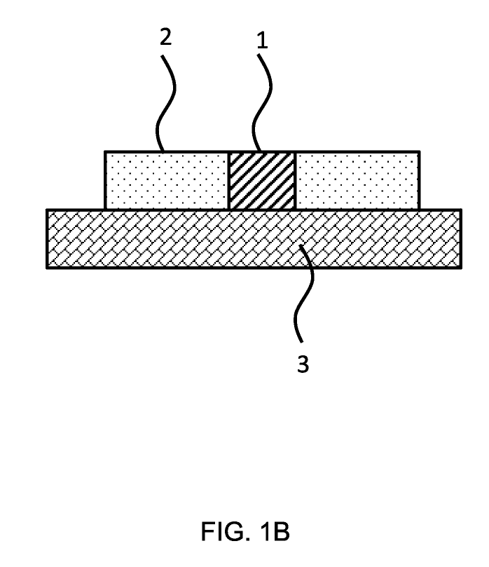

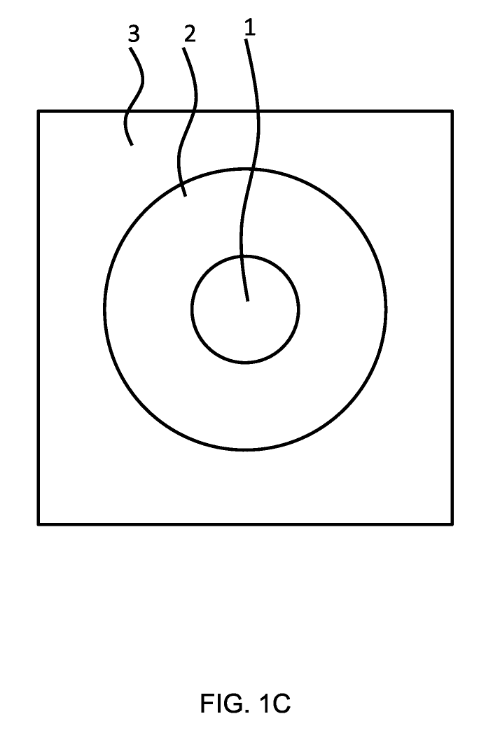

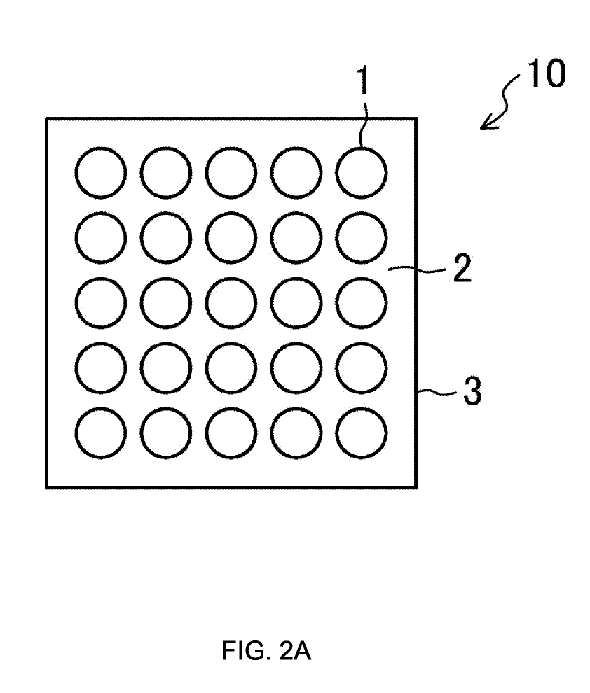

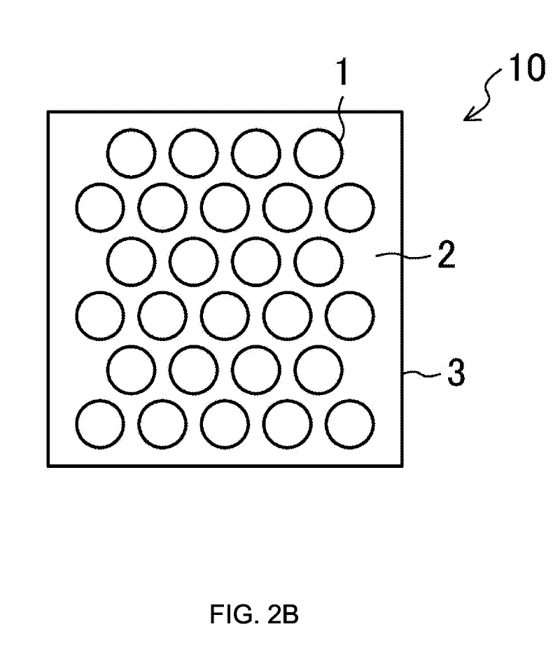

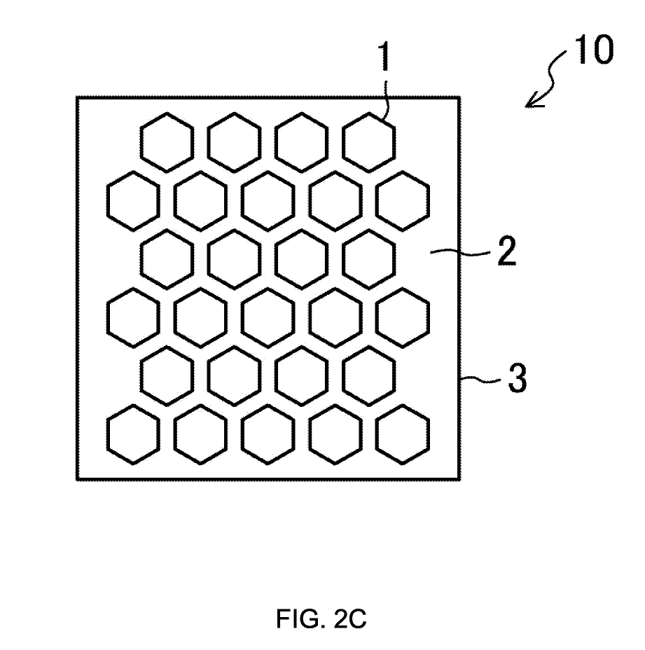

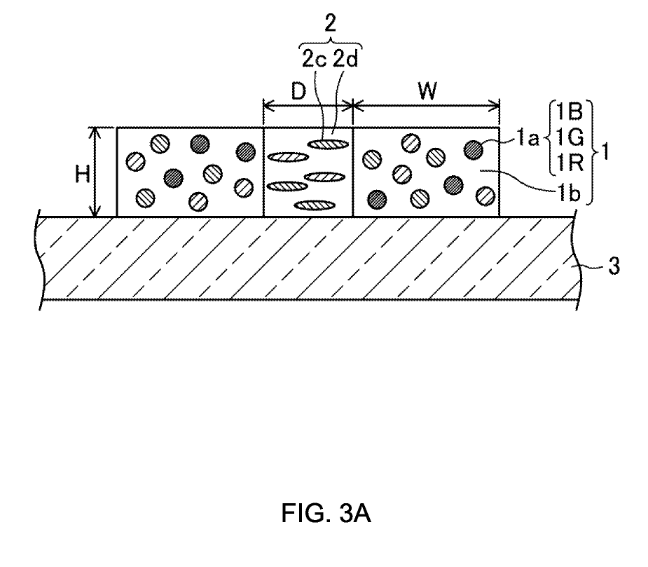

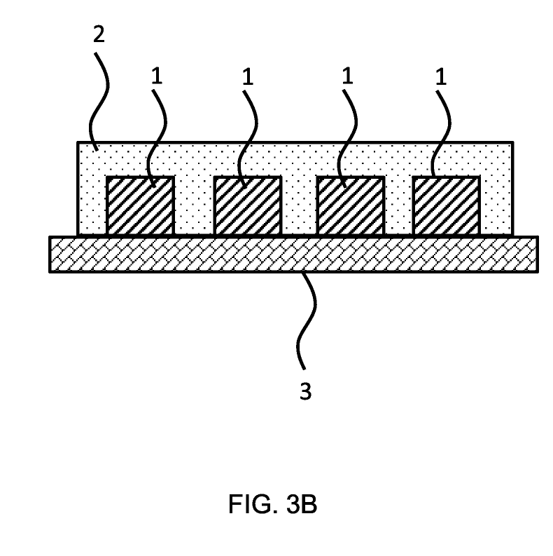

FIG. 1A shows a cross-sectional view of a wavelength conversion board 10 according to the first embodiment. FIG. 2A-FIG. 2C each show a top view of the wavelength conversion board 10 according to the first embodiment. FIG. 3A shows an enlarged cross-sectional view of the wavelength conversion board 10 according to the first embodiment. The cross section of the wavelength conversion board 10 means a section which appears when the wavelength conversion board 10 is cut along a plane including a normal line of the wavelength conversion board 10.

As shown in FIG. 1A, the wavelength conversion board 10 according to the first embodiment comprises a fluorescence member 1, a flexible gel 2, and a substrate 3.

(Fluorescence Member 1)

The fluorescence member 1 converts excitation light emitted from a light source into fluorescence. An example of the light source is a laser diode or a light-emitting diode. In other words, the fluorescence member 1 is irradiated with the excitation light used as input light. Then, the excitation light is converted into the fluorescence by the fluorescence member 1. The fluorescence is output from the fluorescence member 1 as output light. The fluorescence has a longer wavelength than the input light. In this way, the fluorescence member 1 converts a wavelength of the excitation light into a longer wavelength. The fluorescence member 1 is irradiated with the excitation light emitted from the light source such as the laser diode or the light-emitting diode. For this reason, a heat is generated in the fluorescence member 1. However, the heat generated in the fluorescence member 1 is efficiently released from the substrate 3.

Desirably, as shown in FIG. 1A, a plurality of the fluorescence members 1 are disposed on or above the substrate 3 in the cross section of the wavelength conversion board 10. It is more desirable that the plurality of the fluorescence members 1 each having a shape of a dot are disposed in such a manner that the plurality of the fluorescence members 1 are dispersed two dimensionally on the substrate 3.

Instead, as shown in FIG. 1B and FIG. 1C, the wavelength conversion board 10 may be composed of one fluorescence member 1 and a flexible gel 2 surrounding the fluorescence member 1. FIG. 1B shows a cross-sectional view of a first variation of the wavelength conversion board 10 according to the first embodiment. FIG. 1C shows a top view of the first variation of the wavelength conversion board 10 according to the first embodiment.

As shown in FIG. 3A, the fluorescence member 1 is composed of a fluorescence substance 1a and a matrix 1b in which fluorescence particles each formed of the fluorescence substance 1a are dispersed. The matrix 1b may serve as a sealing member. An example of the material of the matrix 1b is an inorganic material or an organic material. An example of the organic material is epoxy resin or silicone resin. An example of the inorganic material is water glass. Another example of the material of the matrix 1b is an organic-inorganic hybrid material in which silsesquioxane has been added to epoxy resin or silicone resin.

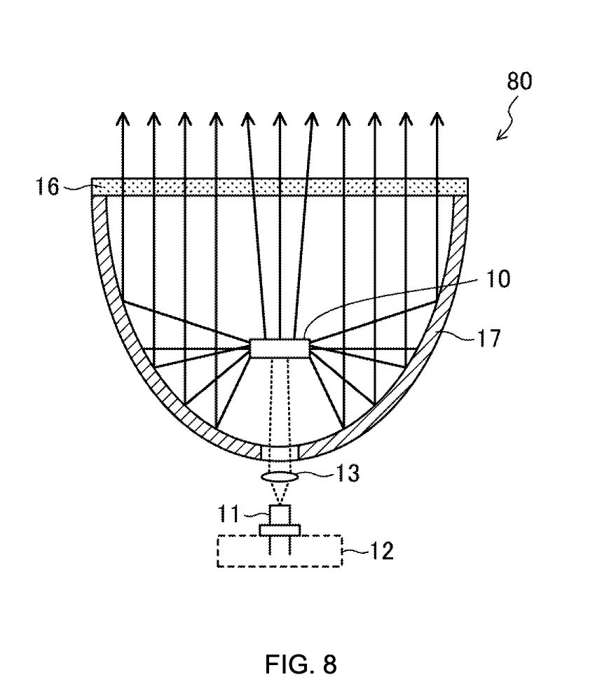

As shown in FIG. 8, which will be described later, blue-violet light is emitted from a light source 11. The blue-violet light is used as the excitation light. The blue-violet light may be incident on the wavelength conversion board 10. The fluorescence substance 1a contains a blue fluorescence substance 1B for converting the blue-violet light into blue light, a red fluorescence substance 1R for converting the blue-violet light into red light, and a green fluorescence substance 1G for converting the blue-violet light into green light.

These blue light, red light, and green light are mixed to output white light from the fluorescence member 1. The blue-violet light has a wavelength of not less than 380 nanometers and not more than 420 nanometers.

An example of the blue fluorescent substance 1B is an Eu-activated BaMgAl₁₀O₁₇ fluorescent substance, an Eu-activated (Sr,Ba)₃MgSi₂O₈ fluorescent substance, or an Eu-activated (Ca,Sr,Ba)₅(PO₄)₃Cl fluorescent substance.

An example of the red fluorescent substance 1R is an Eu-activated (Sr,Ca)AlSiON₃ fluorescent substance, an Eu-activated CaAlSiN₃ fluorescent substance, an Eu-activated Y₂O₂S fluorescent substance, or an Eu-activated (Ca, Li, La)WO₄ fluorescent substance.

An example of the green fluorescent substance 1G is an Eu-activated β-SiAlON fluorescent substance, an Eu-activated SrSi₂O₂N₂ fluorescent substance, an Eu-activated BaSi₃O₄N₂ fluorescent substance, an Eu-activated Ca₈Mg (SiO₄)₄Cl₂ fluorescent substance, an Ce-activated Lu₃Al₅O₁₂ fluorescent substance, or an Ce-activated Y₃(Al,Ga)₅O₁₂ fluorescent substance.

Instead of the blue-violet light, blue light may be used as the excitation light. The blue light has a wavelength of more than 420 nanometers and not more than 480 nanometers. When the blue light is used as the excitation light, the blue fluorescent substance 1B may be omitted. Instead of the red fluorescent substance 1R and the green fluorescent substance 1G, a fluorescent substance for converting the blue-violet light into yellow light may be used.

A coefficient of thermal expansion of the fluorescent member formed of resin is different from a coefficient of thermal expansion of the substrate formed of an inorganic compound or metal. For this reason, when a temperature of the wavelength conversion board is increased or decreased, the fluorescence member may fail to follow the deformation of the substrate caused by the change of the temperature. For this reason, a stress is applied from the substrate to the fluorescence member locally. As a result, a crack occurs in the fluorescence member to lower the reliability of the wavelength conversion board.

In the wavelength conversion board 10 according to the first embodiment, the flexible gel 2 is disposed around the fluorescence member 1. For this reason, even when the substrate 3 is deformed due to the increase or decrease in the temperature of the wavelength conversion board 10, the flexible gel 2 is deformed so as to follow the deformation of the substrate 3. As a result, a smaller stress is applied from the substrate 3 to the fluorescence member 1. In this way, the reliability of the wavelength conversion board 10 is improved.

An example of the content ratio of the fluorescent substance 1a to the matrix 1b is approximately 20%-70% in volume ratio. When the content ratio falls within the range of 20%-70%, the excitation light is efficiently absorbed by the fluorescent substance 1a to output the fluorescence having a different wavelength from the fluorescent substance 1a with high conversion efficiency.

(Flexible Gel 2)

The flexible gel 2 is disposed around the fluorescence member 1. The fluorescence member 1 is disposed on or above the substrate 3. When the plurality of the fluorescence members 1 are disposed on the substrate 3, it is desirable that a space formed between two adjacent fluorescence members 1 is filled with the flexible gel 2 as shown in FIG. 1A.

The flexible gel 2 has high viscosity. On the other hand, the flexible gel 2 does not have fluency. The flexible gel 2 is a solid.

Desirably, the flexible gel 2 is a wet gel. More desirably, the flexible gel 2 is a jelly. As just described, the flexible gel 2 may contain a liquid. Specifically, the flexible gel 2 may have an elastic modulus of not more than 1×10⁵ N/m². It is desirable that the flexible gel 2 has an elastic modulus of not less than 5×10⁰ N/m². An example of such a flexible gel 2 is silicone gel or silicone grease. Typical silicone grease has an elastic modulus of approximately 20×10⁰ N/m².

A gel from which the liquid has been removed by drying is not a flexible gel. For example, a gel provided by a sol-gel method has a significantly high elastic modulus of approximately 5×10⁸ N/m². Note that flexibility is decreased with an increase in the elastic modulus.

As shown in FIG. 3A, the flexible gel 2 may be composed of particles 2c each for reflecting or scattering light and a gel-like material 2d in which the particles 2c are dispersed. In other words, the flexible gel 2 may contain the particles 2c.

The particles 2c prevent the incident excitation light from travelling straightly through the flexible gel 2. The particles 2c reflect the excitation light to the fluorescence member 1 to increase the amount of the fluorescence. An example of the material of the particles 2c is barium oxide, aluminum oxide, or zinc oxide. When blue light is used as the excitation light, titanium oxide may be used instead of aluminum oxide as the material of the particles 2c.

As shown in FIG. 3A, in a cross section of the wavelength conversion board 10, the fluorescence member 1 has a rectangular shape. The fluorescence member 1 has a width of W and a height of H. In the cross section of the wavelength conversion board 10, the flexible gel 2 also has a rectangular shape. The flexible gel 2 has a width of D. The flexible gel 2 may also have a height of H.

As one example, the width D is equal to approximately 25 micrometers. The width W may be approximately 100 micrometers. In this case, the height H may be approximately 50 micrometers. Instead, the width W may be approximately 200 micrometers. In this case, the height H may be approximately 100 micrometers. Instead, the width W may be approximately 1,000 micrometers. In this case, the height H may be approximately 500 micrometers. The wavelength conversion board 10 may be used under a temperature of not less than 30 degrees Celsius and not more than 200 degrees Celsius.

In FIG. 3A, the fluorescence member 1 is as high as the flexible gel 2. However, as shown in FIG. 3B, the flexible gel 2 may be higher than the fluorescence member 1 in the cross section of the wavelength conversion board 10. In other words, the flexible gel 2 may be thicker than the fluorescence member 1. In this way, the fluorescence member 1 may be covered with the flexible gel 2.

Since the fluorescence member 1 is surrounded by the flexible gel 2, the flexible gel 2 follows the deformation of the fluorescence member 1, even when the fluorescence member 1 is deformed due to the expansion or shrinkage of the fluorescence member 1. For this reason, the deformation of the fluorescence member 1 is absorbed by the flexible gel 2.

The shapes of the fluorescence member 1 and the flexible gel 2 are not limited, as far as the fluorescence member 1 is surrounded by the flexible gel 2. For example, in FIG. 2A, a plurality of the cylindrical fluorescence members 1 are regularly disposed on the substrate 3 in such a manner that the centers of the cylindrical fluorescence members 1 correspond to corners of squares. In FIG. 2B, a plurality of the cylindrical fluorescence members 1 are regularly disposed on the substrate 3 in such a manner that the centers of the cylindrical fluorescence members 1 correspond to corners of regular hexagons. In FIG. 2C, a plurality of the fluorescence members 1 each having a shape of a regular hexagonal prism are regularly disposed on the substrate 3 in such a manner that the centers of the cylindrical fluorescence members 1 correspond to corners of regular hexagons. The planar shape of the fluorescence members 1 may be elliptic. The planar shape of the fluorescence members 1 may be polygonal such as triangular, quadrilateral, or pentagonal.

(Substrate 3)

An example of the material of the substrate 3 is metal such as aluminum or a transparent inorganic compound such as glass or sapphire. When the substrate 3 is formed of metal, the wavelength conversion board 10 serves as a light reflection board. When the substrate 3 is formed of the transparent inorganic compound, light penetrates the wavelength conversion board 10.

The substrate 3 may be a dichroic mirror. The dichroic mirror used as the substrate 3 is referred to as a first dichroic mirror. The first dichroic mirror reflects light having a longer wavelength than the wavelength of the blue-violet light. However, the blue-violet light travels through the first dichroic mirror.

When the substrate 3 is a dichroic mirror, the light extraction efficiency from the wavelength conversion board 10 is improved, since a part of the fluorescence given by converting the excitation light which has reached the fluorescence member 1 through the dichroic mirror is reflected by the substrate 3. In other words, the excitation light which has reached the fluorescence member 1 through the substrate 3 is converted into the fluorescence; however, a part of the excitation light is reflected by the fluorescence member 1 to be converted into the fluorescence. Such fluorescence travels to the substrate 3. However, such fluorescence is reflected by the dichroic mirror again. For this reason, the light extraction efficiency from the wavelength conversion board 10 is improved.

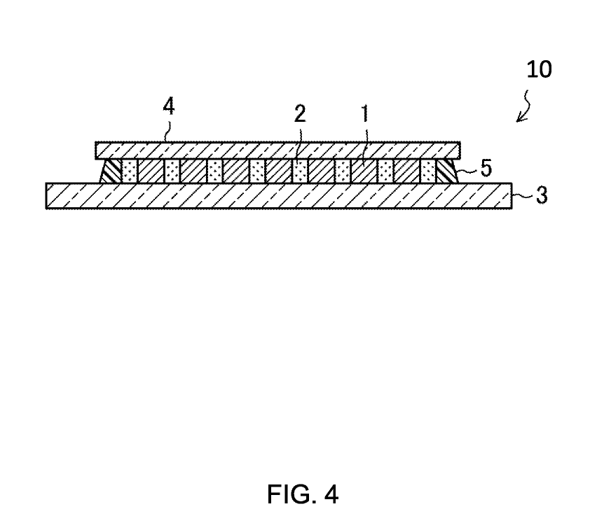

FIG. 4 shows a cross-sectional view of a second variation of the wavelength conversion board 10 according to the first embodiment. As shown in FIG. 4, the wavelength conversion board 10 further comprises a light-transmissive plate 4. The light-transmissive plate 4 is parallel to the wavelength conversion board 10. As shown in FIG. 4, in the cross section of the wavelength conversion board 10, the fluorescence member 1 is interposed between the light-transmissive plate 4 and the substrate 3 along a normal direction of the substrate 3. It is desirable that a sealing member 5 (i.e., adhesive) is disposed around the flexible gel 2 to seal the flexible gel 2 between the substrate 3 and the light-transmissive plate 4. The light-transmissive plate 4 prevents the flexible gel 2 from flowing out from the surface of the wavelength conversion board 10. The sealing member 5 prevents the flexible gel 2 from flowing out from the lateral side of the wavelength conversion board 10. An example of the material of the sealing material 5 is epoxy resin, acrylate resin, or silicone resin.

The light-transmissive plate 4 may be a dichroic mirror. To distinguish the dichroic mirror used as the light-transmissive plate 4 from the dichroic mirror used as the substrate 3, the dichroic mirror used as the light-transmissive plate 4 is referred to as a second dichroic mirror. The second dichroic mirror reflects the blue-violet light. However, the light having a longer wavelength than the wavelength of the blue-violet light travels through the second dichroic mirror. When the excitation light is blue-violet light, the second dichroic mirror blocks the blue-violet light. As a result, desired white light is obtained, since the blue-violet light is not mixed with the white light.

(Fabricating Method)

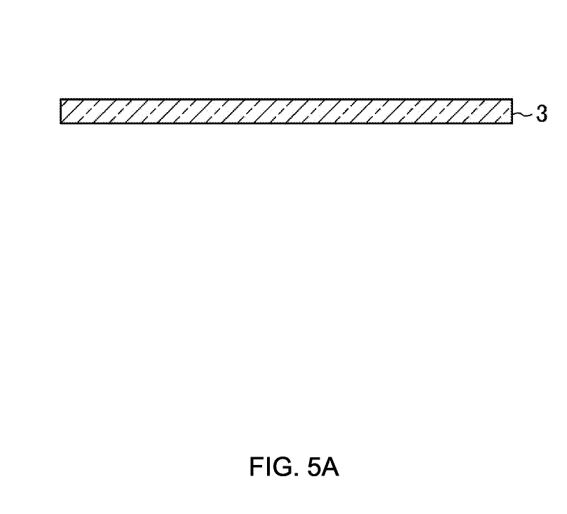

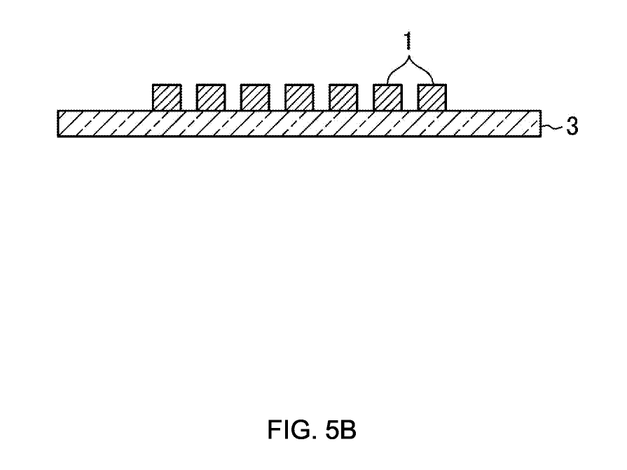

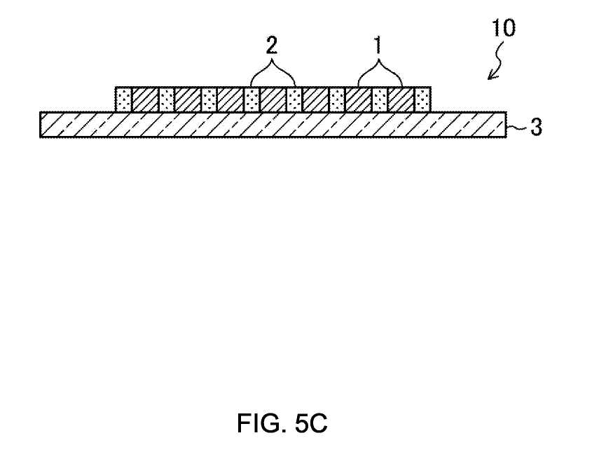

Hereinafter, a method for fabricating the wavelength conversion board 10 according to the first embodiment will be described with reference to FIG. 5A-FIG. 5C.

First, the plate-like substrate 3 is prepared as shown in FIG. 5A.

Then, as shown in FIG. 5B, the matrix 1b in which the fluorescence substance 1a has been dispersed is applied to the surface of the substrate 3 by a screen printing method. Subsequently, the applied matrix 1b is cured. In this way, a plurality of the fluorescence members 1 are formed on the substrate 3 in such a manner that the plurality of the fluorescence members 1 are dispersed on the substrate 3.

As shown in FIG. 5C, the flexible gel 2 is applied using a dispenser on the substrate 3 on which the plurality of the fluorescence members 1 have been formed. The elastic modulus of the flexible gel 2 may be adjusted if necessary. In this way, the wavelength conversion board 10 according to the first embodiment is fabricated.

Then, as shown in FIG. 4, the light-transmissive plate 4 may be provided on the front surface of the wavelength conversion board 10. It is desirable that the sealing member 5 is formed on the substrate 3 between the step shown in FIG. 5B and the step shown in FIG. 5C and that the light-transmissive plate 4 is fixed on the substrate 3 with the sealing member 5. In this way, the wavelength conversion board 10 shown in FIG. 4 is fabricated.

### Second Embodiment

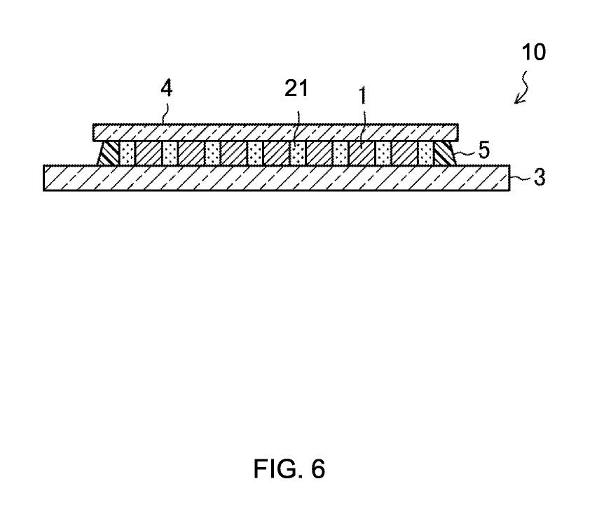

FIG. 6 shows a cross-sectional view of the wavelength conversion board 10 according to the second embodiment. The wavelength conversion board 10 according to the second embodiment is similar to that of the second variation of the first embodiment shown in FIG. 4, except that a fluent material 21 is used instead of the flexible gel 2. Since the fluent material 21 is used in the second embodiment, the light-transmissive plate 4 and the sealing member 5 are required to prevent the fluent material 21 from flowing out from the front surface and the lateral side of the wavelength conversion board 10. Also in the cross-sectional view of the wavelength conversion board 10 according to the second embodiment, as shown in FIG. 3B, the fluent material 21 may be thicker than the fluorescence member 1. The fluent material 21 may contain the particles 2c.

An example of the fluent material 21 is silicone oil.

Similarly to the case of the first embodiment, also in the second embodiment, even when the substrate 3 deforms due to the increase or decrease in the temperature of the wavelength conversion board 10, the fluent material 21 deforms so as to follow the deformation of the substrate 3. For this reason, a smaller stress is applied from the substrate 3 to the fluorescence member 1. In this way, the reliability of the wavelength conversion board 10 is improved.

### Third Embodiment

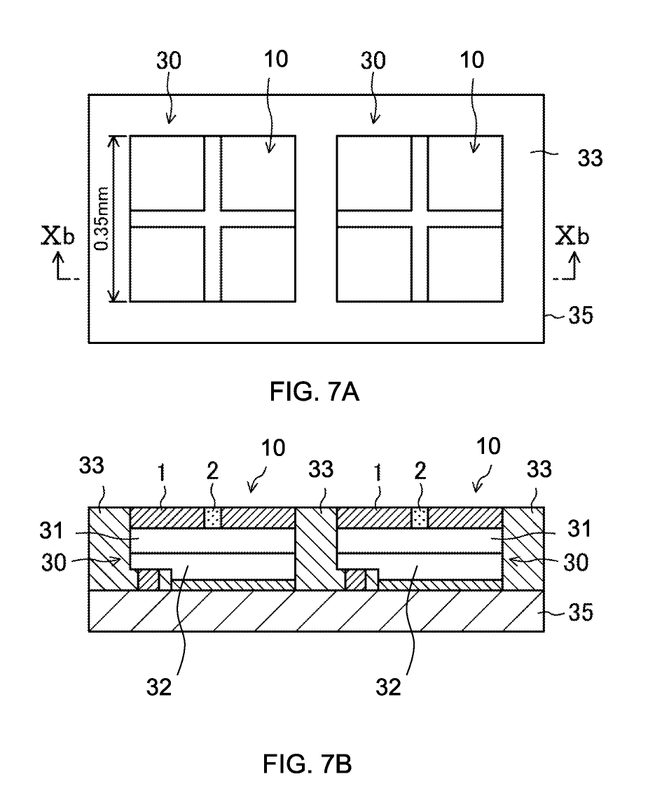

FIG. 7A shows a top view of an illumination device according to the third embodiment. FIG. 7B shows a cross-sectional view taken along the Xb-Xb line included in FIG. 7A. As shown in FIG. 7B, the illumination device according to the third embodiment comprises the wavelength conversion board 10 according to the first or second embodiment and a light-emitting diode 30. The wavelength conversion board 10 is provided on the front surface of the light-emitting diode 30. In the third embodiment, the illumination device may comprise a plurality of the light-emitting diodes 30.

The light-emitting diode 30 comprises a LED substrate 31 and a laminate 32. The laminate 32 comprises a p-side electrode (not shown), a p-type semiconductor layer (not shown), an active layer (not shown), an n-type semiconductor layer (not shown), and an n-side electrode (not shown). The light-emitting diode 30 is mounted on the front surface of a circuit board 35 by junction-down bonding such that the laminate 32 is positioned under the LED substrate 31. In other words, the p-side electrode and the n-side electrode are electrically connected to the electric wiring formed on the circuit board 35. The wavelength conversion board 10 is disposed on the front surface of the LED substrate 31. As just described, the light-emitting diode 30 is interposed between the LED substrate 31 and the circuit board 35. Desirably, the LED substrate 31 is in contact with the wavelength conversion board 10.

The light-emitting diode 30 has a surface area of 0.35 millimeters×0.35 millimeters. As shown in FIG. 7B, the wavelength conversion board 10 has four fluorescence members 1 in the top view. In the top view, a space having a shape of a cross surrounded by the four fluorescence members 1 is filled with the flexible gel 2.

In the cross-sectional view, the light-emitting diode 30 is surrounded by a reflection member 33 formed of titanium oxide.

### Fourth Embodiment

FIG. 8 shows a cross-sectional view of an illumination device according to the fourth embodiment.

As shown in FIG. 8, an Illumination device 80 according to the fourth embodiment comprises the wavelength conversion board 10 according to the first or second embodiment, a light source 11 such as a semiconductor laser diode, a collimating lens 13, a reflection member 17, and a plate-like transparent cover 16. The light source 11 is disposed on a heat sink 12. The collimating lens 13 is disposed between the light source 11 and the reflection member 17. The reflection member 17 has a concave-shaped reflective surface. The wavelength conversion board 10 is disposed near the focal point of the reflection member 17. As just described, in the fourth embodiment, the wavelength conversion board 10 is separated from the light source 11. The transparent cover 16 is provided in front of the illumination device 80. The transparent cover 16 protects the reflective surface of the reflection member 17 and the wavelength conversion board 10.

The light emitted from the light source 11 is converted into parallel light by the collimating lens 13. The parallel light is incident on the wavelength conversion board 10 as excitation light. Fluorescence is output from the wavelength conversion board 10 to all directions. The fluorescence is reflected off the reflection member 17 so as to go forward. Then, the fluorescence is output through the transparent cover 16 to the outside of the illumination device 80.

### Fifth Embodiment

A vehicle according to the fifth embodiment comprises the illumination device 80 according to the fourth embodiment as a vehicle headlamp. The vehicle may be an engine vehicle, an electric vehicle, or a hybrid vehicle.

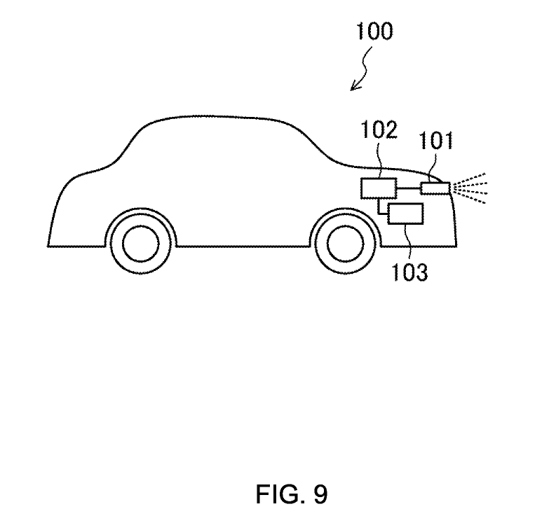

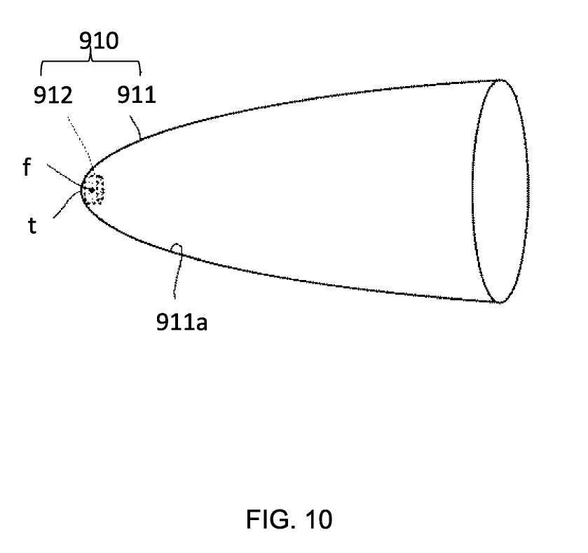

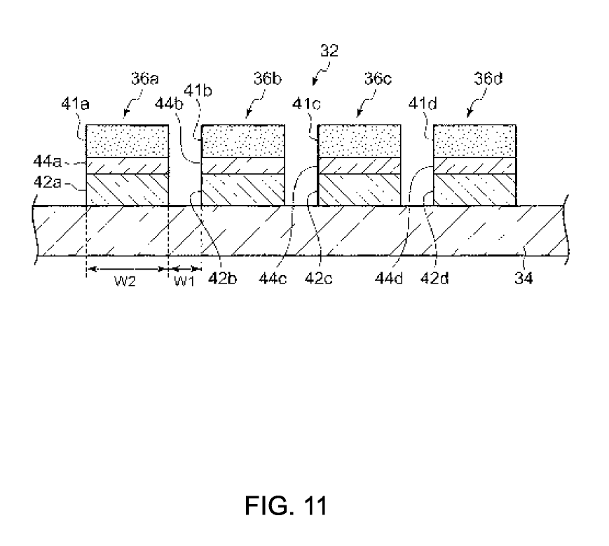

FIG. 9 shows a schematic view of a vehicle 100 according to the fifth embodiment. The vehicle 100 comprises a vehicle headlamp 101 according to the fourth embodiment and an electric power supply source 102. The vehicle 100 may have an electric power generator 103 which generates an electric power by being driven by a driving source such as an engine. The electric power generated by the electric power generator 103 is stored in the electric power supply source 102. An example of the electric power supply source 102 is a rechargeable battery. The vehicle headlamp 101 is maintained on by the electric power supplied from the electric power supply source 102.

The vehicle according to the fifth embodiment comprises the illumination device having high reliability.

### INDUSTRIAL APPLICABILITY

The illumination device comprising the wavelength conversion board according to the present invention can be used for a light source of, for example, a general illumination device such as a ceiling light; a special illumination device such as a spotlight, an illumination for stadiums, or an illumination for studios; a vehicle illumination device such as a headlamp; a projection device such as a projector or a head-up display; a light for endoscopes; an imaging device such as a digital camera, a cellular phone, or a smartphone; or a liquid crystal display device such as a monitor for personal computers, a notebook personal computer, a television, a personal digital assistant (PDA), a smartphone, a tablet personal computer, or a cellular phone.

### REFERENTIAL SIGNS LIST

1 fluorescence member
1a fluorescence substance
1b matrix
1B blue fluorescence substance
1G green fluorescence substance
1R red fluorescence substance
2 flexible gel
2c particle
2d gel-like material
21 fluent material
3 substrate
4 light-transmissive plate
5 sealing member
10 wavelength conversion board
11 light source
12 heat sink
13 collimating lens
16 transparent cover
17 reflection member
30 light-emitting diode
31 LED substrate
32 laminate
33 reflection member
35 circuit board
80 illumination device
100 vehicle
101 headlamp
102 electric power supply source
103 electric power generator

1. A wavelength conversion board, comprising:
a substrate;
one or more fluorescence members each containing a fluorescence substance for converting excitation light into fluorescence, the fluorescence members being each disposed on or above the substrate; and
a flexible gel disposed around the fluorescence member.

2. The wavelength conversion board according to claim 1, wherein
the flexible gel is a wet gel.

3. The wavelength conversion board according to claim 1, wherein
the flexible gel is selected from the group consisting of silicone gel and silicone grease.

4. The wavelength conversion board according to claim 1, wherein
the flexible gel has an elastic modulus of not more than 10⁵ N/m².

5. The wavelength conversion board according to claim 4, wherein
the flexible gel has an elastic modulus of not less than 5 N/m².

6. The wavelength conversion board according to claim 1, wherein
a space formed between two adjacent fluorescence members in a cross section of the wavelength conversion board is filled with the flexible gel.

7. The wavelength conversion board according to claim 1, wherein
the flexible gel is thicker than the fluorescence member in a cross section of the wavelength conversion board; and
the fluorescence member is covered with the flexible gel.

8. The wavelength conversion board according to claim 1, wherein
particles for reflecting or scattering the excitation light are dispersed in the flexible gel.

9. The wavelength conversion board according to claim 1, wherein
wherein the substrate is a dichroic mirror that has blue-violet light travel therethrough and reflects light having a longer wavelength than a wavelength of the blue-violet light.

10. The wavelength conversion board according to claim 1, further comprising:
a light-transmissive plate parallel to the substrate, wherein
the fluorescence members are each interposed between the light-transmissive plate and the substrate in a cross section of the wavelength conversion board.

11. The wavelength conversion board according to claim 10, wherein
the light-transmissive plate is a dichroic mirror that has light having a longer wavelength than a wavelength of blue-violet light travel therethrough and reflects the blue-violet light.

12. The wavelength conversion board according to claim 11, further comprising:
a sealing material disposed around the flexible gel in a cross section of the wavelength conversion board.

13. A wavelength conversion board, comprising:
a substrate;
one or more fluorescence members each containing fluorescence substance for converting excitation light into fluorescence, the fluorescence member being disposed on or above the substrate;
a fluent material disposed around the fluorescence member;
a light-transmissive plate parallel to the substrate; and
a sealing member disposed around the fluent material in a cross section of the wavelength conversion board, wherein
the fluorescence member is interposed between the light-transmissive plate and the substrate in the cross section of the wavelength conversion board.

14. The wavelength conversion board according to claim 13, wherein
a space formed between two adjacent fluorescence members in the cross section of the wavelength conversion board is filled with the fluent material.

15. The wavelength conversion board according to claim 14, wherein
the fluent material is interposed between the fluorescence member and the sealing member along a direction parallel to a surface of the substrate in the cross section of the wavelength conversion board.

16. The wavelength conversion board according to claim 13, wherein
the fluent material is silicone oil.

17. The wavelength conversion board according to claim 13, wherein
the fluent material is thicker than the fluorescence members in the cross section of the wavelength conversion board, and
the fluorescence members are each covered with the fluent material.

18. The wavelength conversion board according to claim 13, wherein
particles for reflecting or scattering the excitation light are dispersed in the fluent material.

19. The wavelength conversion board according to claim 13, wherein
the substrate is a dichroic mirror that has blue-violet light travel therethrough and reflects light having a longer wavelength than a wavelength of the blue-violet light.

20. The wavelength conversion board according to claim 13, wherein
the light-transmissive plate is a dichroic mirror that has light having a longer wavelength than a wavelength of blue-violet light travel therethrough and reflects the blue-violet light.

21. An illumination device, comprising:
the wavelength conversion board according to claim 1, and
a light-emitting element for emitting the excitation light.

22. The illumination device according to claim 21, wherein
the wavelength conversion board is spatially separated from the light-emitting element.

23. An illumination device, comprising:
the wavelength conversion board according to claim 13, and
a light-emitting element for emitting the excitation light.

24. The illumination device according to claim 23, wherein
the wavelength conversion board is spatially separated from the light-emitting element.
